(19) United States
(12) Patent Application Publication
(10) Pub. No.: US 2026/0236953 A1
(43) Pub. Date: Aug. 13, 2026

(54) CANCELLATION PROBABILITY PREDICTION APPARATUS

(71) Applicant: NTT DOCOMO, INC., Tokyo (JP)

(72) Inventors: Hisao KATSUMI, Chiyoda-ku (JP); Kousuke KUBOTA, Chiyoda-ku (JP); Wataru YAMADA, Chiyoda-ku (JP); Keiichi OCHIAI, Chiyoda-ku (JP)

(73) Assignee: NTT DOCOMO, INC., Tokyo (JP)

(21) Appl. No.: 19/475,065

(22) PCT Filed: Jun. 12, 2024
(86) PCT No.: PCT/JP2024/021408

§ 371 Date: Oct. 14, 2025

(30) Foreign Application Priority Data
Jul. 27, 2023 (JP) 2023-122488

(51) Int. Cl. G06Q 30/0202; G06F 11/34

(52) U.S. Cl. CPC G06Q 30/0202; G06F 11/3438

(57) ABSTRACT

The cancellation probability prediction apparatus includes: a first acquirer that acquires for a target user first usage information concerning a usage status of a first application used for provision of a first service; a second acquirer that acquires for the target user second usage information concerning a usage status of a second application used for provision of a second service of the same type as the first service; and a predictor that predicts a probability that the target user will cancel the first service in the future, by inputting the first and the second usage information acquired in a past period into a first learning model having learned a relationship between learning usage statuses of the first and the second applications, and a learning probability that the first service will be canceled in the future. The second usage information includes at least one of: the number of times the second application is activated, or a length of an active time of the second application.

### TECHNICAL FIELD

The present invention relates to cancellation probability prediction apparatuses.

### BACKGROUND ART

A service provider may predict a cancellation probability by customers over a predetermined period from the current time, to estimate the number of customers among whom the provider's service will penetrate during the predetermined period.

For example, Patent Document 1 discloses a sales activity support apparatus that predicts a cancellation probability of customers, to generate a sales activity plan based on the prediction result. The sales activity support apparatus predicts a probability that a customer under a contract is likely to cancel the contract in the near future, based on contract customer information indicating the contract performance from the past to date and analysis target conditions specifying which information within the contract customer information is to be analyzed.

### RELATED ART DOCUMENT

### Patent Document

### Patent Document 1

Japanese Patent Application Laid-Open Publication No. 2021-064406

### SUMMARY OF THE INVENTION

### Problem to be Solved by the Invention

However, conventional methods of predicting the cancellation probability of customers fail to consider the usage status of competing services.

Accordingly, an object of the present invention is to provide a cancellation probability prediction apparatus that predicts a probability of customers canceling a service provider's service based on their usage status of a competing service.

### Means of Solving the Problems

A cancellation probability prediction apparatus according to the present invention includes: a first acquirer configured to acquire first usage information concerning a usage status of a first application for a target user, the first application being used for provision of a first service; a second acquirer configured to acquire second usage information concerning a usage status of a second application for the target user, the second application being used for provision of a second service of a same type as the first service; and a predictor configured to predict a probability that the target user will cancel the first service in the future, by inputting the first usage information and the second usage information acquired in a past period into a first learning model having learned a relationship between (i) a learning usage status of the first application and a learning usage status of the second application, and (ii) a learning probability that the first service will be canceled in the future. The second usage information includes at least one of: the number of times the second application is activated; or a length of an active time of the second application.

### Effect of the Invention

According to the present invention, it is possible to predict a customer cancellation probability for a service provider's service based on a usage status of a competing service.

### BRIEF DESCRIPTION OF THE DRAWINGS

FIG. 1 is a block diagram showing an overall configuration of a cancellation probability prediction system 1.

FIG. 2 is a block diagram illustrating an example configuration of a cancellation probability prediction apparatus 10.

FIG. 3 is an example configuration of a user database UDB1.

FIG. 4 is an example configuration of a message database MDB.

FIG. 5 is an example configuration of a probability table TTB.

FIG. 5 is a block diagram showing an example configuration of a terminal apparatus 20_k.

FIG. 7 is a flowchart showing an operation of the cancellation probability prediction apparatus 10.

FIG. 8 is a block diagram showing an example configuration of a cancellation probability prediction apparatus 10A.

FIG. 9 is an example configuration of a user database UDB2.

### MODES FOR CARRYING OUT THE INVENTION

### 1: First Embodiment

In the following, a cancellation probability prediction system 1 according to the first embodiment will be described with reference to the drawings.

### 1-1: Configuration of First Embodiment

### 1-1-1: Overall Configuration

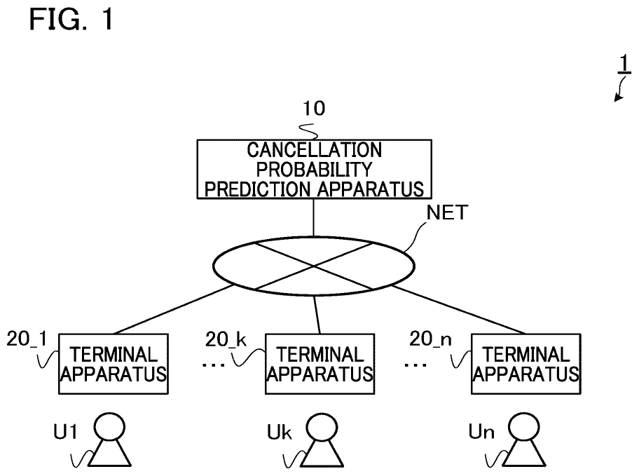

FIG. 1 is a block diagram illustrating an overall configuration of a cancellation probability prediction system 1 according to the present embodiment. As illustrated in FIG. 1, the cancellation probability prediction system 1 includes a cancellation probability prediction apparatus 10 and n terminal apparatuses 20_1 to 20_n. The n is an integer of 1 or more. The terminal apparatuses 20_1 to 20_n include a terminal apparatus 20_k. The k is an integer of 1 to n. In the following, for the sake of simplicity of description, the terminal apparatus 20_k may be described as a representative example of the terminal apparatuses 20_1 to 20_n. In FIG. 1, the number of the terminal apparatuses 20_1 to 20_n is n, which is merely an example. The cancellation probability prediction system 1 includes a freely selected number of terminal apparatuses 20.

Each of the terminal apparatuses 20_1 to 20_n is a device that is used by a user U for using an application installed in each of the terminal apparatuses 20_1 to 20_n. Here, it is assumed that a user Uk uses the terminal apparatus 20-k. The user Uk is an example of a “target user”. The terminal apparatuses 20_1 to 20_n are, for example, smartphones or tablets.

As described later, a first application used for providing a first service and a second application used for providing a second service are installed in each of the terminal apparatuses 20_1 to 20_n. The first service and the second service are the same type of service. For example, a settlement service provided by one provider and a settlement service provided by another provider are the same type of services. In addition, a payment service provided by one provider and a nursing care service provided by another provider are different types of services. The same type of services are services competing with each other. Accordingly, a first provider providing the first service and a second provider providing the second service are in a competitive relationship.

The cancellation probability prediction apparatus 10 predicts a probability that the user Uk will cancel the first service in the future. More specifically, the cancellation probability prediction apparatus 10 predicts a probability that the user Uk will cancel the first service in the future based on a usage status of each of the first application and the second application installed in the terminal apparatus 20-k by the user Uk.

As an example, the first provider providing the first service uses the cancellation probability prediction apparatus 10. In other words, for a provider which uses the cancellation probability prediction apparatus 10, the first service is a service provided by themselves. For this provider, the second service is a competing service.

### 1-1-2: Configuration of Cancellation Probability Prediction Apparatus 10

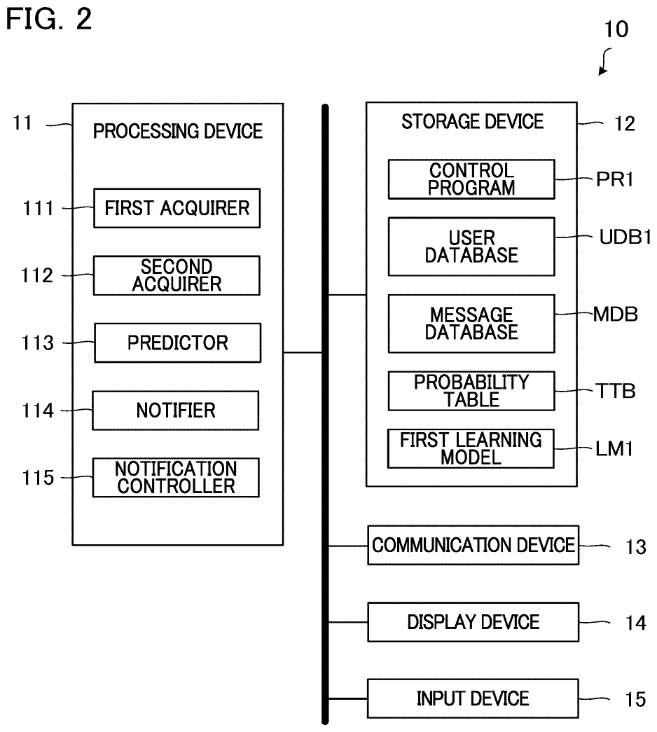

FIG. 2 is a block diagram illustrating an example configuration of the cancellation probability prediction apparatus 10. As illustrated in FIG. 2, the cancellation probability prediction apparatus 10 includes a processing device 11, a storage device 12, a communication device 13, a display device 14, and an input device 15. Each element of the cancellation probability prediction apparatus 10 is connected to each other by a single bus or multiple buses for communicating information. It is to be noted that that the term “apparatus” in this specification may be replaced with other terms such as circuit, device, or unit.

The processing device 11 is a processor that controls the entire cancellation probability prediction apparatus 10. The processing device 11 is configured using, for example, one chip or multiple chips. The processing device 11 is configured using, for example, a CPU (central processing unit) including interfaces with peripheral devices, arithmetic units, registers, and the like. It is to be noted that one, some, or all of the functions of the processing device 11 may be realized by hardware such as a DSP (Digital Signal Processor), an ASIC (Application Specific Integrated Circuit), a PLD (Programmable Logic Device), and an FPGA (Field Programmable Gate Array). The processing device 11 executes various processes in parallel or sequentially.

The storage device 12 is a recording medium that can be read and written by the processing device 11. The storage device 12 includes, for example, a nonvolatile memory and a volatile memory. Non-volatile memories are, for example, a ROM (Read Only Memory), an EPROM (Erasable Programmable Read Only Memory) and an EEPROM (Electrically Erasable Programmable Read Only Memory). The volatile memory is, for example, a RAM (Random Access Memory). Furthermore, the storage device 12 stores a control program PR1 executed by the processing device 11. The storage device 12 functions as a work area of the processing device 11.

The storage device 12 also stores a user database UDB1, a message database MDB, a probability table TTB, and a first learning model LM1.

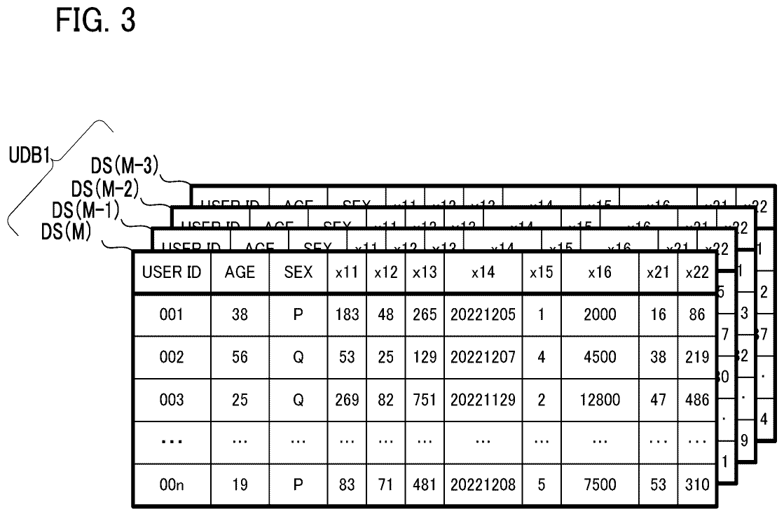

The user database UDB1 stores information concerning each of the users U1 to Un. FIG. 3 illustrates an example configuration of a user database UDB1. In the example shown in FIG. 3, when the current time point is at year Y and month M, the user database UDB1 includes a data set DS(M) which is a collection of data of year Y and month M, a data set DS(M−1) which is a collection of data of year Y and month (M−1), a data set DS(M−2) which is a collection of data of year Y and month (M−2), and a data set DS(M−3) which is a collection of data of year Y and month (M−3). It is to be noted that, in the example shown in FIG. 3, the user database UDB1 includes data sets DS(M) to DS(M−3), which correspond to four months from year Y and month (M−3) to year Y and month M, going backward three months from year Y and month M. However, this is merely an example. The user database UDB1 may include data sets from DS(M−L) to DS(M), which correspond to a freely selected number of months, i.e., L months, going backward L months from “year Y and month M”.

The data set DS(M) includes, as items, user ID, age, sex, items x11 to x16, and items x21 to x22.

The “user ID” is an identifier for identifying a user U who uses the first application. For example, the user ID of the user U1 is “001”. The user ID of the user U2 is “002”. The user ID of the user Uk is “00k”. The user ID of the user Un is “00n”. “Age” is the age of each of the users U1 to Un at year Y and month M. In the data set DS(M), as an example, it is indicated that the age of the user U1 corresponding to the user ID=“001” is 38 years old. The “sex” is the sex of each of the users U1 to Un. In the example shown in FIG. 3, “P” indicates male. “Q” indicates female. In the data set DS(M), as an example, it is indicated that the sex of user U1 corresponding to the user ID=“001” is male.

Items x11 to x16 are items concerning the first service or the first application. Item x11 indicates a contract duration since each of the users U1 to Un started using the first service. In the data set DS(M), as an example, the contract duration of the user U1 corresponding to the user ID=“001” is indicated to be 183 months.

Item x12 indicates the number of times that each of the users U1 to Un activated the first application during year Y and month M. In the data set DS(M), it is indicated that the number of activations of the first application in year Y and month M by the user U1 corresponding to user ID=“001” is 48, for example.

Item x13 indicates the length of time during which each of the users U1 to Un had the first application active during year Y and month M. In the data set DS(M), it is indicated that, as an example, the active time of the first application during year Y and month M for the user U1 corresponding to the user ID=“001” is 265 minutes.

Item x14 indicates, as of the present time, the date and time at which each of the users U1 to Un last used the first application. In the data set DS(M), as an example, it is indicated that the user U1 corresponding to the user ID=“001” and the date and time at which the first application was last used was Dec. 5, 2022. Alternatively, item x14 may be, as of the end of year Y and month M, the date and time at which each of the users U1 to Un last used the first application.

Item x15 indicates the number of times each of the users U1 to Un visited the website of a provider providing the first service during year Y and month M. In the data set DS(M), as an example, it is indicated that the number of times the user U1 corresponding to the user ID=“001” visited the website of the provider providing the first service during year Y and month M is one.

Item x16 indicates the total amount of money spent by each of the users U1 to Un through using the first service by using the first application during year Y and month M. In the data set DS(M), as an example, it is indicated that the total amount of money spent by the user U1 corresponding to the user ID=“001” during year Y and month Mis JPY 2,000.

Item x21 to item x22 are items concerning the second service or the second application. Item x21 indicates the number of times that each of the users U1 to Un activated the second application during year Y and month M. In the data set DS(M), it is indicated that the number of activations of the second application in year Y and month M by the user U1 corresponding to user ID=“001” is 16, as an example.

Item x22 indicates the length of time that each of the users U1 to Un had the second application active during year Y and month M. In the data set DS(M), it is indicated that, as an example, the active time of the first application during year Y and month M for the user U1 corresponding to the user ID=“001” is 86 minutes.

In the above example, the data set DS(M) includes six items x11 to x16 as items concerning the first service or the first application. However, the data set DS(M) may have any number of items as items concerning the first service or the first application. Furthermore, the items concerning the first service or the first application included in the data set DS(M) are not limited to the contract duration since the use of the first service started, the number of times the first application was activated, the length of time during which the first application was active, the date and time at which the first application was last used, the number of times the website of the first service provider was visited, and the total amount of money spent. The data set DS(M) may include other types of items as items concerning the first service or the first application.

In addition, in the above-described embodiment, the data set DS(M) includes two items x21 and x22 as items concerning the second service or the second application. However, the data set DS(M) may have any number of items as items concerning the second service or the second application. Furthermore, the items concerning the second service or the second application included in the data set DS(M) are not limited to the number of times the second application was started and the length of time during which the second application was active. The data set DS(M) may have other types of items as items concerning the second service or the second application.

As described above, the data set DS(M) includes first usage information concerning the usage status of the first application and second usage information concerning the usage status of the second application. The first usage information includes attribute information concerning attributes of a user U. In the example shown in FIG. 3, the attribute information is information concerning the age and sex of the user U. In addition, the first usage information includes at least one of the date and time that the user U last used the first service as of year Y and month M, the number of times that the user U used the first service during year Y and month M, or the amount of money spent by the user U for using the first service during year Y and month M.

The data sets DS(M−1) to DS(M−3) have the same configuration as that of the data set DS(M).

The message database MDB in FIG. 2 stores messages sent from the cancellation probability prediction apparatus 10 to the terminal apparatuses 20_1 to 20_n. Each of the messages is a message that prompts the users U1 to Un to use the first service.

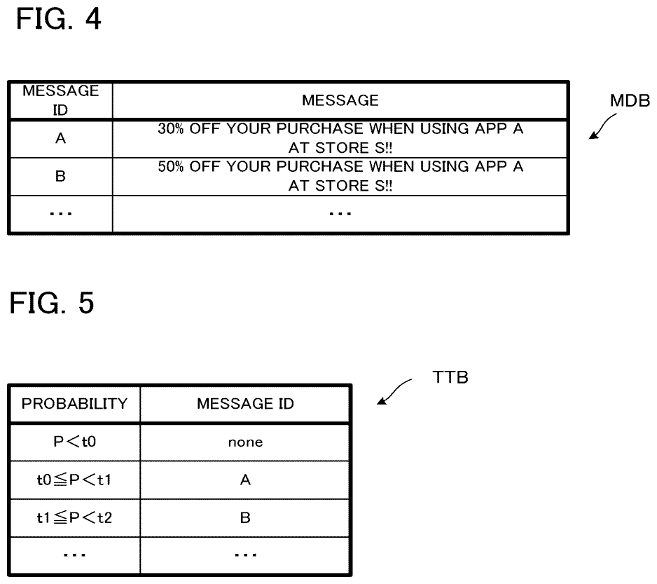

FIG. 4 illustrates an example configuration of the message database MDB. The message database MDB includes, as items, a message ID and a message.

The “message ID” is an identifier for identifying a message. The “message” is the body portion of the message. The message body may consist of text only. Alternatively, the message body may be composed of text and images.

In the message database MDB illustrated in FIG. 4, a message with the message ID “A” notifies that 30% of the purchase amount will be discounted when a product or service is purchased using application A at store S. A message with the message ID “B” notifies that 50% of the purchase amount will be discounted when a product or service is purchased using application A at store S. The “application A” here is an example of the first application. The “store S” is preferably a store where both the first service and the second service are available.

In the example illustrated in FIG. 4, two messages having message IDs of “A” and “B” are stored in the message database MDB. However, the number of messages stored in the message database MDB may be any number.

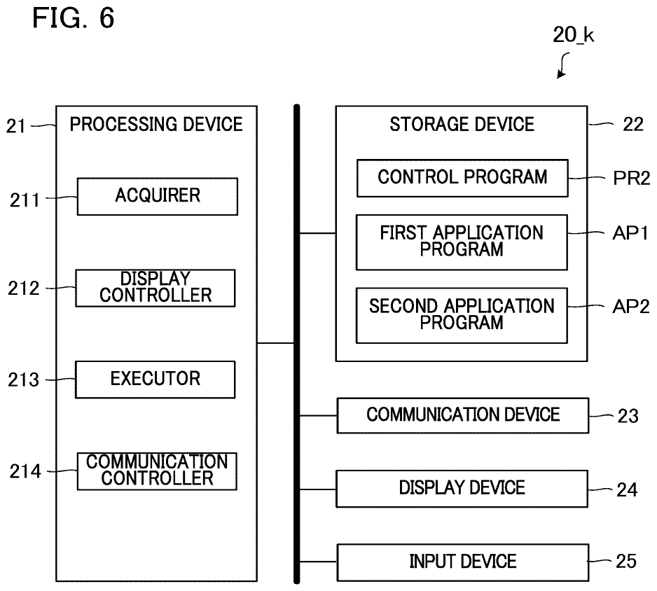

The probability table TTB in FIG. 2 defines correspondences between a probability predicted by the cancellation probability prediction apparatus 10 and the message ID of a message sent from the cancellation probability prediction apparatus 10 to the terminal apparatuses 20_1 to 20_n. FIG. 5 illustrates an example configuration of the probability table TTB. The probability table TTB has, as items, a probability and a message ID.

The probability table TTB illustrated in FIG. 5 defines that, in a case in which the probability P that the user U will cancel the first service in the future is less than to, the cancellation probability prediction apparatus 10 does not send a message to the terminal apparatus 20 used by the user U. Furthermore, the probability table TTB defines that, in a case in which the probability P is equal to or greater than to and less than t1, the cancellation probability prediction apparatus 10 notifies the terminal apparatus 20 used by the user U with a message having a message ID of “A”. Furthermore, the probability table TTB defines that, in a case in which the probability P is equal to or greater than t1 and less than t2, the cancellation probability prediction apparatus 10 notifies the terminal apparatus 20 used by the user U with a message having a message ID of “B”.

The first learning model LM1 is a learning model used when the predictor 113, which will be described later, predicts a probability that the user U will cancel the first service in the future. The first learning model LM1 is a trained learning model that has learned the relationship between (i) a learning usage status of the first application and a learning usage status of the second application and (ii) a learning probability that the first service will be canceled in the future. The learning usage status of the first application and the learning usage status of the second application comprise one or more pieces of information included in, for example, the data sets DS(M−L) to DS(M−1) during a period from year Y and month (M−L) to year Y and month (M−1) in the user database UDB1. In a case in which the first application is Aown, the second application is Acomp, and a feature concerning the learning usage status of the application A in month t for the user Uk is a feature x_{k, t}(A), a feature X_{k, M}(Aown, Acomp) concerning the learning usage status of the first application and the learning usage status of the second application included in the training data of the first learning model LM1 is expressed by the following equation.

$${X}_{\text{?}} ( {A}_{\text{?}} , {A}_{\text{?}} ) = ( {x}_{\text{?}} ( {A}_{\text{?}} ) , {x}_{\text{?}} ( {A}_{\text{?}} ) , … , {x}_{\text{?}} ( {A}_{\text{?}} ) , {x}_{\text{?}} ( {A}_{\text{?}} ) , {x}_{\text{?}} ( {A}_{\text{?}} ) , … , {x}_{\text{?}} ( {A}_{\text{?}} ) ) \qquad [ Formula 1 ]$$

$$\text{?} \text{indicates text missing or illegible when filed}$$

The feature x_{k, t}(Aown) comprises, for example, one or more of the values of item x11 to item x16 corresponding to the user Uk and the attribute information of the user Uk and in the data sets DS(M−L) to DS(M−1). These features are features obviously causally related to the churn of users from the first service. Furthermore, it is considered that these features have no clear correlation with the usage status of the second service. In general, it is expected that, as long as there is no correlation between features, the prediction accuracy will be improved by adding a feature casually related to a target variable as a feature to be input into a learning model. Therefore, the accuracy of the churn prediction is improved by adding, as one or more features to the training data of the first learning model LM1, one or more of the values of the items x11 to x16 and the attribute information of the users U1 to Un.

The feature x_{k, t}(Acomp) is, for example, one or more of the values of the item x21 to the item x22 corresponding to the user Uk in the data sets DS(M−L) to DS(M−1). The accuracy of the churn prediction will be further improved by adding, to the training data of the first learning model LM1, one or more of the values of the items x21 to x22, which is the feature x_{k, t}(Acomp) of the competing service, in addition to the feature x_{k, t}(Aown) of the service provider's service.

Furthermore, a learning probability that the first service will be canceled in the future is a probability indicating how many users U out of a plurality of users U associated with the learning usage status of the same first application and the learning usage status of the second application will cancel the first service in the future. The “future” is, for example, the immediately following one-month period. Furthermore, the “plurality of users U associated with the learning usage status of the same first application and the learning usage status of the second application” means, for example, a plurality of users U belonging to the same group when grouped into a plurality of groups depending on the values for each of the items indicating the learning usage status of the first application and the learning usage status of the second application.

The training data used to generate the first learning model LM1 includes a plurality of pairs of (i) a learning usage status of the first application and a learning usage status of the second application, and (ii) a learning probability that the first service will be canceled in the future.

Furthermore, the first learning model LM1 is generated outside the cancellation probability prediction apparatus 10. The first learning model LM1 is preferably generated by a server (not shown). In this case, the cancellation probability prediction apparatus 10 acquires the first learning model LM1 from the server (not shown) via the communication network NET.

The communication device 13 is hardware as a transmitting and receiving device for communicating with other devices. The communication device 13 is also referred to as, for example, a network device, a network controller, a network card, a communication module, or the like. The communication device 13 may include a connector for wired connection, and may include an interface circuit corresponding to the connector. The communication device 13 may include a wireless communication interface. Connectors and interface circuitry for wired connection include wired LAN, IEEE1394, and USB compliant products. Examples of the wireless communication interfaces include products in compliance with wireless LAN and Bluetooth (registered trademark).

The display device 14 is a device that displays images and text information. The display device 14 displays various images under the control of the processing device 11. For example, a variety of display panels such as a liquid crystal display panel and an organic EL display panel is preferably used as the display device 14.

The input device 15 is a device that receives an operation from an administrator of the cancellation probability prediction apparatus 10. For example, the input device 15 includes a pointing device such as a keyboard, a touch pad, a touch panel, or a mouse. In a case in which the input device 15 includes a touch panel, the input device 15 may also serve as the display device 14.

The processing device 11 functions as, for example, a first acquirer 111, a second acquirer 112, a predictor 113, a notifier 114, and a notification controller 115 by reading and executing the control program PR1 from the storage device 12.

The first acquirer 111 acquires, via the communication device 13 from the terminal apparatus 20_1 to the terminal apparatus 20_n, the first usage information concerning the usage statuses of the first application used for providing the first service, for the users U1 to Un as target users. The first acquirer 111 stores the acquired first usage information in the user database UDB1. The first usage information concerning the usage statuses of the users U1 to Un acquired by the first acquirer 111 includes first usage information concerning the usage status of the user Uk.

The second acquirer 112 acquires, via the communication device 13 from the terminal apparatus 20_1 to the terminal apparatus 20_n, the second usage information concerning the usage statuses of the second application used for providing the second service, for the users U1 to Un as the target users. The second acquirer 112 stores the acquired second usage information in the user database UDB1. The second usage information concerning the usage statuses of the users U1 to Un acquired by the second acquirer 112 includes the second usage information concerning the usage status of the user Uk. The second usage information includes at least one of the number of times the second application is activated or the length of the active time of the second application.

The predictor 113 predicts a probability Pk that the user Uk will cancel the first service in the future by inputting into the first learning model LM1 the first usage information and the second usage information of the user Uk acquired in the past period. The training data used to generate the first learning model LM1 comprises, for example, a pair of (i) the learning usage status of the first application and the learning usage status of the second application, for the users U1 to Un during a period from year Y and month (M−L) to year Y and month (M−1), and (ii) the learning probability, that the first service will be canceled within one month from the date corresponding to the learning usage statuses. In addition, the first usage information and the second usage information of the user Uk that the predictor 113 inputs into the first learning model LM1 are, for example, the first usage information and the second usage information of year Y and month M. Furthermore, the probability Pk predicted by the predictor 113 is, for example, a probability that the user Uk will cancel the first service during the period from year Y and month M to year Y and month (M+1). It is preferable that the items of the first usage information and the second usage information of the user Uk input by the predictor 113 to the first learning model LM1 be the same as the items of the usage information of the first application and the usage information of the second application included in the training data.

In addition, the predictor 113 may predict the probability P that the first service will be canceled, not only for the user Uk, but also for one or more users U other than the user Uk, from among the users U1 to Un.

The notifier 114 notifies the terminal apparatus 20-k used by the user Uk of a message for promoting the use of the first service. The message is a message stored in the message database MDB. In addition, as described above, the content of the message is preferably content indicating a benefit for promoting the use of the first service in a store where the first service and the second service are available.

By referring to the probability table TTB, the notification controller 115 controls depending on the probability P predicted by the predictor 113 at least one of (i) whether to send a message by the notifier 114 or (ii) the content of the message. Referring to the probability table TTB illustrated in FIG. 5, in a case in which the probability P is less than t0, the notification controller 115 does not cause the notifier 114 to send any messages. In a case in which the probability P is equal to or greater than to and less than t1, the notification controller 115 causes the notifier 114 to send the message corresponding to the message ID=“A”. In a case in which the probability P is equal to or greater than t1 and less than t2, the notification controller 115 causes the notifier 114 to send the message corresponding to the message ID=“B”. Referring to FIG. 4, the message corresponding to the message ID=“A” and the message corresponding to the message ID=“B” are associated with different proportions deducted from the purchased amount. That is, the notification controller 115 controls the benefit depending on the probability P predicted by the predictor 113. In this example, the greater the probability P, the more favorable the benefit is given to the target user.

### 1-1-3: Configuration of Terminal Apparatus 20_k

FIG. 6 is a block diagram illustrating an example configuration of the terminal apparatus 20-k. As illustrated in FIG. 6, the terminal apparatus 20-k includes a processing device 21, a storage device 22, a communication device 23, a display device 24, and an input device 25. The respective elements of the terminal apparatus 20_k are connected to each other by a single bus or by multiple buses for communicating information.

The processing device 21 is a processor that controls the entire terminal apparatus 20-k. The processing device 21 is configured using, for example, one or more chips. The processing device 21 is configured using, for example, a CPU (central processing unit) including interfaces with peripheral devices, arithmetic units, registers, and the like. It is to be noted that one or more of the functions of the processing device 21 may be realized by hardware such as a DSP, an ASIC, a PLD, and an FPGA. The processing device 21 executes various processes in parallel or sequentially.

The storage device 22 is a recording medium that can be read from and written to by the processing device 21. The storage device 22 includes, for example, a nonvolatile memory and a volatile memory. Non-volatile memories are, for example, a ROM, an EPROM and an EEPROM. The volatile memory is, for example, a RAM. In addition, the storage device 22 stores a control program PR2 executed by the processing device 21. The storage device 22 functions as a work area of the processing device 21.

Furthermore, the storage device 22 stores the first application program AP1 and the second application program AP2. The first application program AP1 is a program for operating the first application used by the user Uk. The second application program AP2 is a program for operating a second application used by the user Uk.

The communication device 23 is hardware as a transmitter and receiver device for communicating with other devices. The communication device 13 is also referred to as, for example, a network device, a network controller, a network card, a communication module, or the like. The communication device 23 may include a connector for wired connection, and may include an interface circuit corresponding to the connector. The communication device 23 may include a wireless communication interface. Connectors and interface circuitry for wired connection include wired LAN, IEEE1394, and USB compliant devices. Examples of the wireless communication interfaces include wireless LAN and Bluetooth (registered trademark).

The display device 24 is a device that displays images and text information. The display device 24 displays various images under the control of the processing device 21. For example, a variety of display panels such as a liquid crystal display panel and an organic EL display panel is preferably used as the display device 24.

The input device 25 is a device that receives an operation from a user Uk. For example, the input device 25 includes a pointing device such as a keyboard, a touch pad, a touch panel, or a mouse. In a case in which the input device 25 includes a touch panel, the input device 25 may also serve as the display device 24.

The processing device 21 functions as, for example, an acquirer 211, a display controller 212, an executor 213, and a communication controller 214 by reading and executing the control program PR2 from the storage device 22.

The acquirer 211 acquires a message notified from the cancellation probability prediction apparatus 10 via the communication device 23. The message is a message prompting the use of the first service as described above.

The display controller 212 causes the display device 24 to display the message acquired by the acquirer 211.

The executor 213 executes the first application program AP1 and the second application program AP2 stored in the storage device 22 based on an input to the input device 25 carried out by the user Uk.

The communication controller 214 causes the communication device 23 to transmit, to the cancellation probability prediction apparatus 10, the first usage information concerning the usage status of the user Uk for the first application. In addition, the communication controller 214 causes the communication device 23 to transmit, to the cancellation probability prediction apparatus 10, the second usage information concerning the usage status of the user Uk for the second application. When the terminal apparatus 20_k is a smartphone or a tablet, the second usage information transmitted by the communication controller 214 is acquired from an event log of the smartphone or the tablet.

### 1-2: Operation of First Embodiment

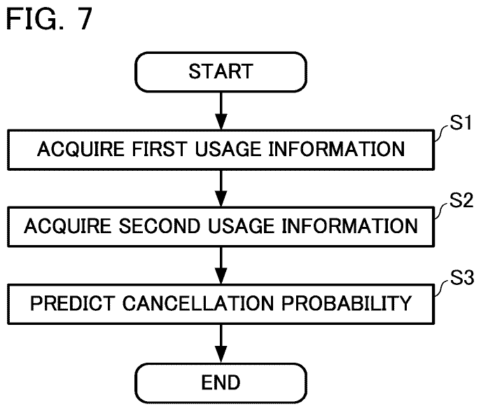

FIG. 7 is a flowchart illustrating an operation of the cancellation probability prediction apparatus 10.

At Step S1, the processing device 11 functions as the first acquirer 111. The processing device 11 acquires first usage information concerning the usage statuses of the first application used for providing the first service for the users U1 to Un as target users.

At Step S2, the processing device 11 functions as the second acquirer 112. The processing device 11 acquires second usage information concerning the usage statuses of the second application used for providing the second service for the users U1 to Un as the target users.

At Step S3, the processing device 11 functions as the predictor 113. The processing device 11 predicts probabilities P1 to Pn that users U1 to Un will cancel the first service in the future by inputting the first usage information and the second usage information acquired in the past period to the first learning model LM1.

### 1-3: Effects of First Embodiment

The cancellation probability prediction apparatus 10 according to the present embodiment includes the first acquirer 111, the second acquirer 112, and the predictor 113. The first acquirer 111 acquires the first usage information concerning the first application usage statuses used for providing the first service for the users U1 to Un as the target users. The second acquirer 112 acquires the second usage information concerning the usage statuses of the second application used to provide the second service of the same type as the first service, for the users U1 to Un as the target users. The predictor 113 predicts a probability Pk that the user Uk will cancel the first service in the future by inputting the first usage information and the second usage information acquired in the past period to the first learning model LM1 that has learned a relationship between (i) the learning usage status of the first application and the learning usage status of the second application and (ii) the probability that the first service will be canceled in the future. The second usage information includes at least one of the number of times the second application is activated or the length of the active time of the second application.

The cancellation probability prediction apparatus 10 with the above configuration can predict a customer cancellation probability in the service provider's service based on the usage status of the competing service. Furthermore, by adding the feature xk,t(Acomp) of the competing service to the training data of the first learning model LM1 in addition to the feature xk,t(Aown) of the provider's service, the accuracy of the churn prediction is improved.

Furthermore, in the cancellation probability prediction apparatus 10, the first usage information includes attribute information concerning the attributes of the users U1 to Un.

The attribute information includes, for example, age and sex. In general, age and sex are correlated with a degree of willingness to change a service in use to another service. Therefore, in the cancellation probability prediction apparatus 10 with the above-described configuration, the accuracy of the churn prediction is improved by adding one or more of the attribute information of the users U1 to Un as the features to the training data of the first learning model LM1.

Furthermore, in the cancellation probability prediction apparatus 10, the first usage information includes at least one of (i) date and time when each of the users U1 to Un last used the first service, (ii) number of times each of the users U1 to Un used the first service in a past period, or (iii) amount of money spent by each of the users U1 to Un to use the first service in the past period.

Generally, there is a correlation between the number of days being small from the date and time at which the first service was last used to the current time and the degree of proactiveness in switching the currently used service to another service. In addition, there is a correlation between the number of times being small in which each of the users U1 to Un has used the first service during the past period and the degree of willingness to switch the currently used service to another service. Furthermore, there is a correlation between the amount of money spent by each of the users U1 to Un to use the first service during the past period and the degree of willingness to switch the currently used service to another service. In the cancellation probability prediction apparatus 10 with the above configuration, the accuracy of the churn prediction is improved by adding to the training data of the first learning model LM1 at least one of (i) date and time when each of the users U1 to Un last used the first service, (ii) number of times each of the users U1 to Un used the first service during a past period, or (iii) amount of money spent by each of the users U1 to Un to use the first service within the past period.

The cancellation probability prediction apparatus 10 further includes the notifier 114 and the notification controller 115. The notifier 114 notifies the user Uk of a message prompting the user to use the first service. The notification controller 115 controls at least one of (i) whether to send a message or (ii) content of the message, depending on the probability Pk predicted by the predictor 113.

In the cancellation probability prediction apparatus 10 with the above configuration, the usage rate of the first service by the user Uk is likely to be improved.

In addition, in the cancellation probability prediction apparatus 10, the content of the message indicates a benefit for prompting the use of the first service in a store where the first service and the second service are available. The notification controller 115 controls the above-described benefit depending on the probability Pk prediction by the predictor 113.

Rather than providing the benefit for promoting the use of the first service in a store where only the first service is available, the provision of the benefit for promoting the use of the first service in a store where the first service and the second service are available can increase the usage rate of the first service, which is the provider's own service, as compared with the usage rate of the second service, which is the competing service. The cancellation probability prediction apparatus 10 with the above-described configuration can reduce the probability that the user Uk will cancel the first service. Furthermore, the cancellation probability prediction apparatus 10 can set the content of the benefit in a detailed manner, depending on the probability P predicted by the predictor 113.

### 2: Second Embodiment

In the following, a cancellation probability prediction system 1A according to a second embodiment will be described with reference to the drawings. In the following, for the sake of simplicity of explanation, the description will primarily focus on the differences between the cancellation probability prediction system 1A and the cancellation probability prediction system 1. In addition, among the constituent elements included in the cancellation probability prediction system 1A, the same constituent elements as those included in the cancellation probability prediction system 1 are denoted by the same reference numerals, and descriptions of the functions thereof may be omitted.

### 2-1: Configuration of Second Embodiment

### 2-1-1: Overall Configuration

The overall configuration of the cancellation probability prediction system 1A according to the present embodiment includes a cancellation probability prediction apparatus 10A in place of the cancellation probability prediction apparatus 10, as compared with the cancellation probability prediction system 1 according to the first embodiment. In other respects, since the overall configuration of the cancellation probability prediction system 1A is the same as the overall configuration of the cancellation probability prediction system 1, illustration thereof is omitted.

### 2-1-2: Configuration of Cancellation Probability Prediction Apparatus 10A

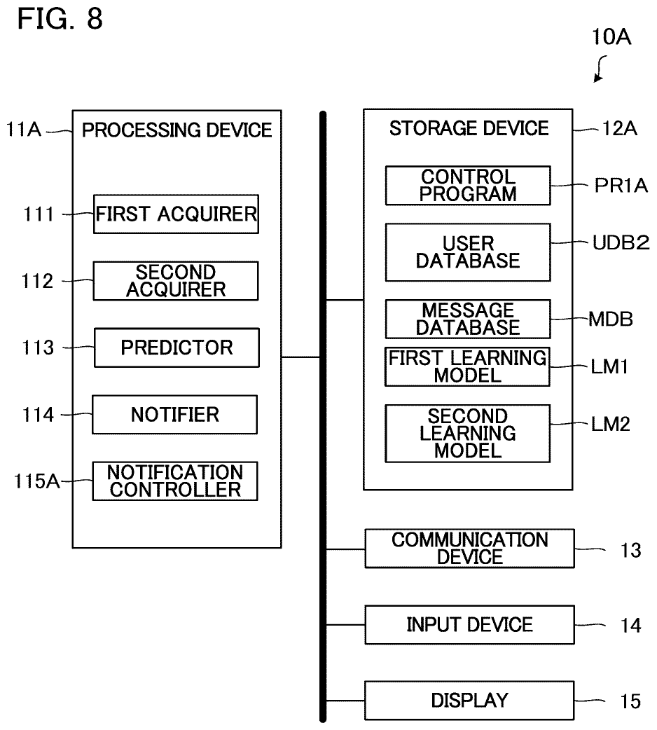

FIG. 8 is a diagram illustrating an example configuration of the cancellation probability prediction apparatus 10A. The cancellation probability prediction apparatus 10A differs from the cancellation probability prediction apparatus 10 in that a processing device 11A is provided in place of the processing device 11, and a storage device 12A is provided in place of the storage device 12.

The storage device 12A differs from the storage device 12 in that a control program PRIA is provided in place of the control program PR1 and a user database UDB2 is provided in place of the user database UDB1. Furthermore, the storage device 12A does not include the probability table TTB provided in the storage device 12. On the other hand, the storage device 12A includes a second learning model LM2 that is not provided in the storage device 12.

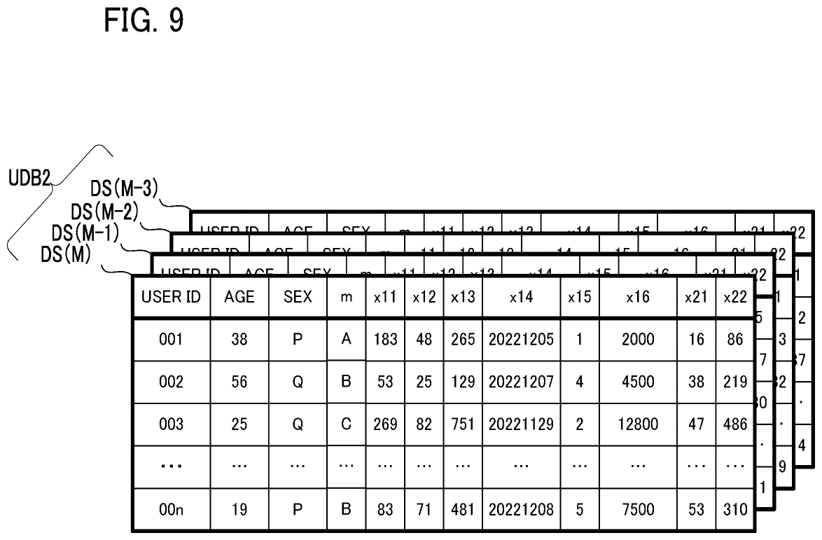

FIG. 9 illustrates an example configuration of the user database UDB2. When the user database UDB2 is compared with the user database UDB1, the data set DS(M) included in the user database UDB2 includes item m in addition to the item included in the data set DS(M) included in the user database UDB1. Item m is a message ID of a message notified by the cancellation probability prediction apparatus 10A to each of the users U1 to Un. In the data set DS(M), the message ID of the message notified to the user U1 corresponding to the user ID=“001” is “A”. In other words, the message notified to the user U1 is a message corresponding to the message ID=“A” in the message database MDB illustrated in FIG. 4. The first row of the data set DS(M) indicates that, as a result of a notification by the cancellation probability prediction apparatus 10A to notify the user U1 of the message corresponding to the message ID=“A”, the user U1 used the first service for JPY 2,000.

The data sets DS(M−1) to DS(M−3) have the same configuration as that of the data set DS(M).

In FIG. 8, the second learning model LM2 is a learning model into which the notification controller 115A (described later) inputs the first usage information and the second usage information acquired in the past period, to acquire the content of the message. The second learning model LM2 is a trained learning model configured such that a learning amount of money spent is maximized, by using training data indicating the learning usage status of the first application, the learning usage status of the second application, the learning content of the message, and the learning amount of money spent on the first service. The learning usage status of the first application and the learning usage status of the second application comprise one or more pieces of information included in, for example, data sets DS(M−L) to DS(M−1) during a period from year Y and month (M−L) to year Y and month (M−1) in the user database UDB2. The content of the message is the content of a message associated with the message ID of the item m included in the data sets DS(M−L) to DS(M−1). The learning amount of money spent on the first service is the amount of money spent under item x16 included in the data sets DS(M−L) to DS(M−1). The training data used to generate the second learning model LM2 includes a plurality of sets of a learning usage status of the first application, a learning usage status of the second application, learning content of the message, and a learning amount of money spent on the first service.

For example, when the content of the message is “a”, the second learning model LM2 learns the following association between X and Y for each of the users U1 to Un.

$$( X = \{ {x}_{11} , {x}_{12} , {x}_{21} , a \} , Y = \{ {x}_{16} \} ) \qquad [ Formula 2 ]$$

Alternatively, the second learning model LM2 may be a trained learning model configured such that the learning number of times the first application is activated is maximized, by using training data indicating the learning usage status of the first application, the learning usage status of the second application, the learning content of the message, and the learning number of times the first application is activated. Alternatively, the second learning model LM2 may be a trained learning model configured such that the learning conversion rate is maximized, by using training data indicating the learning usage status of the first application, the learning usage status of the second application, the learning content of the message, and the learning conversion rate in the first application.

The processing device 11A functions as, for example, a first acquirer 111, a second acquirer 112, a predictor 113, a notifier 114, and a notification controller 115A by reading and executing the control program PRIA from the storage device 12A.

The notification controller 115A acquires the content of the message by inputting to the second learning model LM2 the first usage information and the second usage information acquired in the past period. In addition, the notification controller 115A sets the content of the message sent by the notifier 114 as the content of the acquired message.

### 2-2: Operation of Second Embodiment

Since the operation of the cancellation probability prediction apparatus 10A is the same as the operation of the cancellation probability prediction apparatus 10 shown in FIG. 7, illustration and description thereof are omitted.

### 2-3: Effects of Second Embodiment

In the cancellation probability prediction apparatus 10A according to the present embodiment, the notification controller 115A acquires the content of an output message that is output by inputting the first usage information and the second usage information acquired in the past period to the trained second learning model LM2 configured such that the learning amount of money spent is maximized, using the training data indicating the learning usage status of the first application, the learning usage status of the second application, the learning content of the message, and the learning amount of money spent on the first service. The notification controller 115A sets the content of the message sent by the notifier 114 to be the content of the acquired output message.

With the above configuration, the cancellation probability prediction apparatus 10A can notify the user Uk of a message with the aim of increasing the amount of money spent on the first service. Consequently, the cancellation probability prediction apparatus 10A can reduce the probability that the user Uk will cancel the first service.

Furthermore, in the cancellation probability prediction apparatus 10A according to the present embodiment, the notification controller 115A acquires the content of the output message, which is output by inputting into the trained second learning model LM2 the first usage information and the second usage information acquired in the past period. The second learning model has been trained such that the learning number of times the first application is activated is maximized, by using the training data indicating the learning usage status of the first application, the learning usage status of the second application, the learning content of the message, and the learning number of times the first application is activated. In addition, the notification controller 115A sets the content of the message sent by the notifier 114 to be the content of the acquired output message.

The cancellation probability prediction apparatus 10A with the above-described configuration can notify the user Uk of a message, with the aim of increasing the number of times the first application is activated. Consequently, the cancellation probability prediction apparatus 10A can reduce the probability that the user Uk will cancel the first service.

Furthermore, in the cancellation probability prediction apparatus 10A according to the present embodiment, the notification controller 115A acquires the content of the output message, which is output by inputting into to the trained second learning model LM2 the first usage information and the second usage information acquired in the past period. The second learning model LM2 has been trained such that the learning conversion rate is maximized, by using the training data indicating the learning usage status of the first application, the learning usage status of the second application, the learning content of the message, and the learning conversion rate in the first application. In addition, the notification controller 115A sets the content of the message sent by the notifier 114 to be the content of the acquired output message.

With the above configuration, the cancellation probability prediction apparatus 10A can notify the user Uk of a message, with the aim of increasing the conversion rate in the first application. Consequently, the cancellation probability prediction apparatus 10A can reduce the probability that the user Uk will cancel the first service.

### 3: Modifications

The present disclosure is not limited to the embodiments illustrated above. Specific variations are exemplified below. Two or more embodiments optionally selected from the following examples may be combined.

### 3-1: Modification 1

In the above-described embodiment, for a user that uses the cancellation probability prediction apparatus 10 and the cancellation probability prediction apparatus 10A, the first service is the service provided by the user. However, the first service may not be the service provided by the user.

### 4: Other Matters

(1) In the foregoing embodiments, as examples of the storage device 12, the storage device 12A, and the storage device 22, a ROM, a RAM, and the like have been described. However, the storage device 12, the storage device 12A, and the storage device 22 may each be a flexible disk, a magneto-optical disk (for example, a compact disc, a digital versatile disc, or a Blu-ray (registered trademark) disc), a smart card, a flash memory device (for example, a card, a stick, or a key drive), a compact disc-ROM (CD-ROM), a register, a removable disk, a hard disk, a floppy (registered trademark) disk, a magnetic strip, a database, a server, or another appropriate storage medium. A program may be transmitted from a network via an electric communication line. The programs may be transmitted from the communication network NET via the electric communication line.

(2) In the foregoing embodiments, the information, signal, or the like may be expressed by using any of various different techniques. For example, data, an order, a command, information, a signal, a bit, a symbol, a chip, or the like that can be referred to throughout the description above may be expressed by using a voltage, a current, electromagnetic waves, a magnetic field or a magnetic particle, a photo field or a photon, or any combination thereof.
(3) In the foregoing embodiments, information or the like that has been input or output may be stored in a specified place (for example, a memory), or may be managed by using a management table. The information or the like that has been input or output can undergo overwriting, updating, or postscripting. The information or the like that has been output may be deleted. The information or the like that has been input may be transmitted to another apparatus.
(4) In the foregoing embodiments, determination may be performed on the basis of a value (0 or 1) expressed by using one bit, may be performed on the basis of a Boolean value (true or false), or may be performed on the basis of a comparison between numerical values (for example, a comparison with a predetermined value).
(5) In a processing procedure, a sequence, a flowchart, or the like that has been described as an example in the embodiments described above, the order may be changed without conflicting. For example, in the method described in the present disclosure, various step elements have been provided by using an illustrative order, and the specified order that has been provided is not limiting.
(6) The respective functions illustrated in FIGS. 1 to 9 are implemented by any combination of at least one of hardware and software. A method for implementing respective function blocks is not particularly limited. Stated another way, the respective function blocks may be implemented by using a single physically or logically coupled device, or may be implemented by directly or indirectly (for example, in a wired manner, in a wireless manner, or the like) connecting two or more devices that are physically or logically separated, and using these plural devices. The function blocks may be implemented by a combination of the single device described above or the plural devices described above and software.
(7) The foregoing programs as an example in the embodiments described above are to be broadly construed as meaning of an order, an order set, a code, a code segment, a program code, a program, a sub-program, a software module, an application, a software application, a software package, a routine, a subroutine, an object, an executable file, an execution thread, a procedure, a function, or the like, regardless of whether the programs are referred to as software, firmware, middleware, a microcode, a hardware description language, or another term.

Software, an order, information, or the like may be transmitted or received via a transmission medium. For example, when software is transmitted from a website, a server, or another remote source by using at least one of a wired technique (a coaxial cable, an optical fiber cable, a twisted-pair wire, a digital subscriber line (DSL), or the like) or a wireless technique (infrared rays, microwaves, or the like), at least one of these wired and wireless techniques falls under the definition of the transmission medium.
(8) In each of the embodiments described above, the terms “system” and “network” are compatibly used.
(9) The information, the parameter, or the like that has been described in the present disclosure may be expressed by using an absolute value, may be expressed by using a value relative to a predetermined value, or may be expressed by using other corresponding information.
(10) In the foregoing embodiments, the terminal apparatuses 20_1 to 20_n may include a mobile station (MS) in some cases. In some cases, the mobile station is referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other appropriate terms by those skilled in the art. In the present disclosure, the terms “mobile station”, “user terminal”, “user equipment (UE)”, “terminal”, and the like can be compatibly used.
(11) In the foregoing embodiments, the terms “connected”, and “coupled”, or all transformations thereof mean all types of direct or indirect connection or coupling of two or more elements, and include that one or more intermediate elements exist between two elements that are “connected” or “coupled” to each other. Coupling or connection of elements may be physical coupling or connection, logical coupling or connection, or a combination thereof. For example, “connection” may be replaced with “access”. In the case of use in the present disclosure, it can be considered that two elements are “connected” or “coupled” to each other by using at least one of one or more electric wires, cables, and printed electrical connection, and by using electromagnetic energy or the like having wavelengths of, as some non-limiting and non-comprehensive examples, a wireless frequency range, a microwave region, and a (both visible and invisible) light region.
(12) In the foregoing embodiments, the description “on the basis of” does not mean “solely on the basis of” unless otherwise specified. In other words, the description “on the basis of” means both “solely on the basis of” and “at least on the basis of”.
(13) The term “determining” used in the present disclosure includes a variety of operations in some cases. The “determining” can include, for example, that “judging”, “calculating”, “computing”, “processing”, “deriving”, “investigating”, “looking up, searching, or inquiring” (for example, looking up, searching, or inquiring in a table, a database, or another data structure), ascertaining is considered as “determining”. The term “determining” can include, for example, that “receiving” (for example, receiving information), “transmitting” (for example, transmitting information), “input”, “output”, or “accessing” (for example, accessing data in a memory) is considered as “determining”. The term “determining” can include “resolving”, “selecting”, “choosing”, “establishing”, “comparing”, or the like is considered as “determining”. Stated another way, “determining” can include that any kind of operation is considered as “determining”. The term “determining” may be replaced with “assuming”, “expecting”, “considering”, or the like.
(14) In the embodiments described above, in a case in which “include” “including”, and the modifications thereof are used, these terms are intended to be comprehensive in substantially the same manner as the term “comprising”. The term “or” used in the present disclosure is not intended to be the exclusive OR.
(15) In the present disclosure, for example, in a case in which an article, such as a, an, or the, is added, the present disclosure may include nouns that follow these articles are plural.
(16) In the present disclosure, the description “A and B are different” may mean “A and B are different from each other”. The description may mean “each of A and B is different from C”. The terms “separated”, “coupled”, and the like may be construed in substantially the same manner as “different”.
(17) Respective aspects and embodiments described in the present disclosure may be used individually, may be combined and used, or may be switched and used according to execution. A report of predetermined information (for example, a report of “X”) is not limited to a report that is explicitly made, and may be implicitly made (for example, without making a report of the predetermined information).

In the foregoing, the present disclosure is described in detail, and it is clear to one skilled in the art that the present disclosure is not limited to the embodiment described in the present disclosure. The present disclosure can be carried out as modified and changed modes without departing from the scope of the gist of the present disclosure that is defined by the descriptions of the claims. Consequently, the descriptions of the present disclosure are for the purpose of explanation by raising examples and have no restrictive meaning for the present disclosure.

### DESCRIPTION OF REFERENCE SIGNS

1: cancellation probability prediction system, 1A: cancellation probability prediction system, 10: cancellation probability prediction apparatus, 10A: cancellation probability prediction apparatus, 11: processing device, 11A: processing device, 12: storage device, 12A: storage device, 13: communication device, 14: display device, 15: input device, 20: terminal apparatus, 20_1: terminal apparatus, 20_k: terminal apparatus, 20_n: terminal apparatus, 21: processing device, 22: storage device, 23: communication device, 24: display device, 25: input device, 111: first acquirer, 112: second acquirer, 113: predictor, 114: notifier, 115: notification controller, 115A: notification controller, 211: acquirer, 212: display controller, 213: executor, 214: communication controller, A: application, AP1: first application program, AP2: second application program, DS: data set, LM1: first learning model, LM2: second learning model, MDB: message database, NET: communication network, P: probability, P1: probability, PR1: control program, PR1A: control program, PR2: control program, Pk: probability, TTB: probability table, U: user, U1: user, U2: user, UDB1: user database, UDB2: user database, Uk: user, Un: user

1. A cancellation probability prediction apparatus comprising:
a first acquirer configured to acquire first usage information concerning a usage status of a first application for a target user, wherein the first application is used for provision of a first service;
a second acquirer configured to acquire second usage information concerning a usage status of a second application for the target user, wherein the second application is used for provision of a second service of a same type as the first service; and
a predictor configured to predict a probability that the target user will cancel the first service in a future, by inputting the first usage information and the second usage information acquired in a past period into a first learning model having learned a relationship between:
a learning usage status of the first application and a learning usage status of the second application; and
a learning probability that the first service will be canceled in the future,
wherein the second usage information includes at least one of:
a number of times the second application is activated; or
a length of an active time of the second application.

2. The cancellation probability prediction apparatus according to claim 1,
wherein the first usage information includes attribute information concerning an attribute of the target user.

3. The cancellation probability prediction apparatus according to claim 1,
wherein the first usage information includes at least one of:
a date and time at which the target user last used the first service;
a number of times the target user used the first service during the past period; or
an amount of money spent for using the first service during the past period.

4. The cancellation probability prediction apparatus according to claim 1, further comprising:
a notifier configured to notify the target user of a message prompting use of the first service; and
a notification controller configured to control, based on the probability predicted by the predictor, at least one of:
whether to send the message; or
content of the message.

5. The cancellation probability prediction apparatus according to claim 4,
wherein:
the content of the message indicates a benefit for prompting the use of the first service at a store where both the first service and the second service are available, and
the notification controller is configured to control the benefit based on the probability predicted by the predictor.

6. The cancellation probability prediction apparatus according to claim 4, wherein:
the notification controller is configured to acquire content of an output message output by inputting, into a second learning model, the first usage information and the second usage information acquired in the past period, wherein the second learning model has been trained using training data indicating:
a learning usage status of the first application;
a learning usage status of the second application;
a learning message content; and
a learning amount of money spent on the first service,
such that the learning amount of money spent on the first service is maximized, and
the notification controller is configured to set the content of the message sent by the notifier to be the content of the acquired output message.

7. The cancellation probability prediction apparatus according to claim 4, wherein:
the notification controller is configured to acquire content of an output message output by inputting, into a second learning model, the first usage information and the second usage information acquired in the past period, wherein the second learning model has been trained using training data indicating:
a learning usage status of the first application;
a learning usage status of the second application;
a learning message content; and
a learning number of times the first application is activated,
such that the learning number of times the first application is activated is maximized, and
the notification controller is configured to set the content of the message notified by the notifier to be the content of the acquired output message.

8. The cancellation probability prediction apparatus according to claim 4, wherein
the notification controller is configured to acquire content of an output message output by inputting, into a second learning model, the first usage information and the second usage information acquired in the past period, wherein the second learning model has been trained using training data indicating:
a learning usage status of the first application;
a learning usage status of the second application;
a learning message content; and
a learning conversion rate in the first application,
such that the learning conversion rate in the first application is maximized, and
the notification controller is configured to set the content of the message notified by the notifier to be the content of the acquired output message.
